(19) United States
(12) Patent Application Publication
(10) Pub. No.: US 2010/0076842 A1
(43) Pub. Date: Mar. 25, 2010

(54) Gaming System and Game Controller

(76) Inventor: Dusan Berlec, Menges (SI)

Correspondence Address: MCANDREWS HELD & MALLOY, LTD, 500 WEST MADISON STREET, SUITE 3400, CHICAGO, IL, 60661, US

(21) Appl. No.: 12/469,165

(22) Filed: May 20, 2009

(30) Foreign Application Priority Data
May 20, 2008 (SI) 2008902490

(51) Int. Cl. G06Q 30/00; G01S 15/00; G01J 5/00

(52) U.S. Cl. 705/14.49; 367/93; 250/338.1

(57) ABSTRACT

A gaming system comprising: a game controller adapted to control game play; at least one player interface in data communication with the game controller and operable by a player to enter game play instructions; an advertising module; and at least one sensor adapted to detect a person proximate a player interface and trigger the advertising module to advertise availability of the player interface when the player interface is not in use.

### RELATED APPLICATIONS

This application claims priority to Australia Patent Application No. 2008902490 having a filing date of May 20, 2008, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to gaming systems and game controllers therefore.

Gaming systems having single or multiple player interfaces are known. Several such gaming systems are often provided at a single venue to enabling players to choose the gaming system they wish to play.

There is a need for alternative ways to attract player interest in gaming systems.

### BRIEF SUMMARY OF THE INVENTION

According to one aspect there is provided a gaming system comprising:
a game controller adapted to control game play;
at least one player interface in data communication with the game controller and operable by a player to enter game play instructions;
an advertising module; and
at least one sensor adapted to detect a person proximate a player interface and trigger the advertising module to advertise availability of the player interface when the player interface is not in use.

In an embodiment the game system comprises a plurality of player interfaces. In this embodiment a sensor can be provided for each player interface. An advertising module can also be implemented for each player interface.

In an embodiment the advertising module is implemented in the game controller.

The game controller can be in data communication with the sensors, whereby the game controller receives a signal generated by a sensor when a person is detected by the sensor and the game controller is adapted to determine whether the detected person is proximate an unused player interface and trigger advertisement of the availability of the player interface.

In an embodiment the gaming system can be further adapted to determine whether a person detected proximate a player interface is moving towards or away from the player interface.

Advertising the availability of a player interface can comprise one or more of flashing lights and making sounds.

In an embodiment the sensors are infrared sensors adapted to detect the presence of a person based on detecting a difference between body heat of a person and ambient temperature.

In another embodiment the sensors are ultrasound sensors adapted to emit and receive ultrasound waves and detect the presence of a person based on ultrasound waves reflected by the person. The sensor may be adapted to determine whether the person is moving toward or away from a player interface based on changes in reflected ultrasound waves.

According to another aspect there is provided a player interface for a game system, the player interface comprising:
an input mechanism adapted to enable a player to enter game play instructions;
a sensor adapted to detect a person proximate the player interface; and
an advertising module adapted to, in response to detection of a person in the zone when the player interface is not in use, advertise availability of the player interface.

According to another aspect there is provided a method of advertising availability of a gaming system for play comprising the steps of:
detecting the presence of a person proximate a player interface of the game system;
determining whether the player interface is in use by a player; and
advertising the availability of the player interface.

In an embodiment where the gaming system comprises a plurality of player interfaces, the step of detecting the presence of a person proximate a player interface can include determining which of the plurality of player interfaces the person is proximate to.

A detection area proximate the player terminal can be based on a sensing range of at least one sensor in at least one direction from the player interface. The detection area may be adjustable in some embodiments.

Detecting the presence of a person can include:
activating a sensor;
sensing the presence of a person within sensing range of the sensor;
determining whether the person is proximate a player interface; and
signaling the detected presence of the person proximate the player interface.

Detecting the presence of a person may further comprise determining whether the person is moving towards or away from the sensor.

### BRIEF DESCRIPTION OF SEVERAL VIEWS OF THE DRAWINGS

An embodiment, incorporating all aspects of the invention, will now be described by way of example only with reference to the accompanying drawings in which

FIG. 1 is a block diagram of the core components of a gaming system;

FIG. 2 is a block diagram of an example of the functional components of a gaming machine;

FIG. 3 is a block diagram of an example of a game system with player detection;

FIG. 4 is a perspective view of an example of a stand alone gaming machine;

FIG. 5 is a diagram schematic of an example of a networked gaming system;

FIG. 6 illustrates an example of a multi terminal game system with player detection;

FIG. 7 is a flowchart of an example of a player detection process;

### DETAILED DESCRIPTION OF THE INVENTION

The present invention relates to player detection in gaming systems. Player detection can be implemented in a stand alone gaming system a distributed or network based gaming system or a multi terminal gaming system. Embodiments may be applied to any type of game, such as a spinning reel game, poker, keno, bingo, pinball, dice etc.

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

In a third form a multi terminal gaming machine is provided wherein a plurality of players can each wager on the outcome of the same random result generation process. The multi terminal gaming system comprises a plurality of player interfaces in data communication with a single game controller that applies game rules and each player's game play instructions to a random result to determine a game outcome for each player.

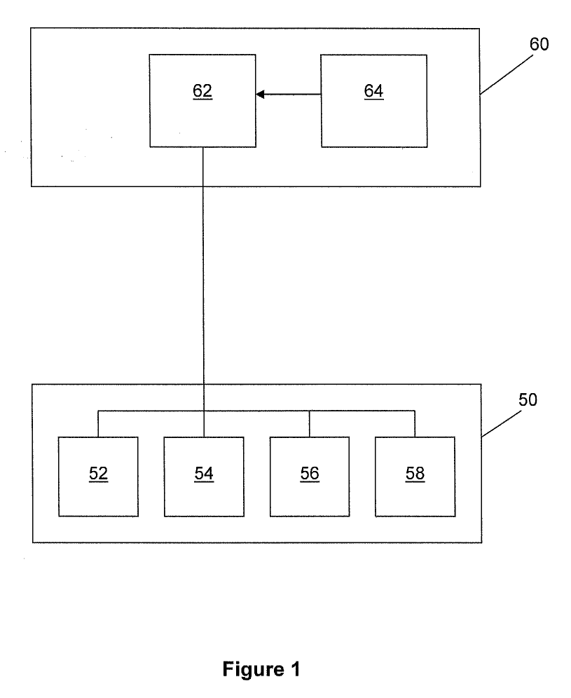

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game and observe the game outcomes.

Components of the player interface may vary from embodiment to embodiment but will typically include a credit mechanism 52 to enable a player to input credits and receive payouts, one or more displays 54 and a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

Embodiments can be provided with one or more sensors adapted to detect the presence of a person proximate a player interface. The sensors can be any device which can be used to detect a change characteristic of the presence of a person and generate a signal in response to the detection. For example, infra red sensors or ultrasonic sensors adapted to detect the presence of a person through detecting movement or changes in temperature. Alternatively, piezoelectric sensors adapted to detect pressure from a person standing on or walking over a section of floor or a mat may be used. A signal output from the sensor can trigger an advertising module implemented in the processor 62 to take action to attract the person's attention if the player interface is not in use, to encourage the person to play. For example the advertising module may cause activation of one or more of the displays 54, such as showing an advertisement for the game on a screen type display, or causing lighting up or flashing of lights on a light panel type display. A tune or audio advertisement for the game may also be output using the speakers 58.

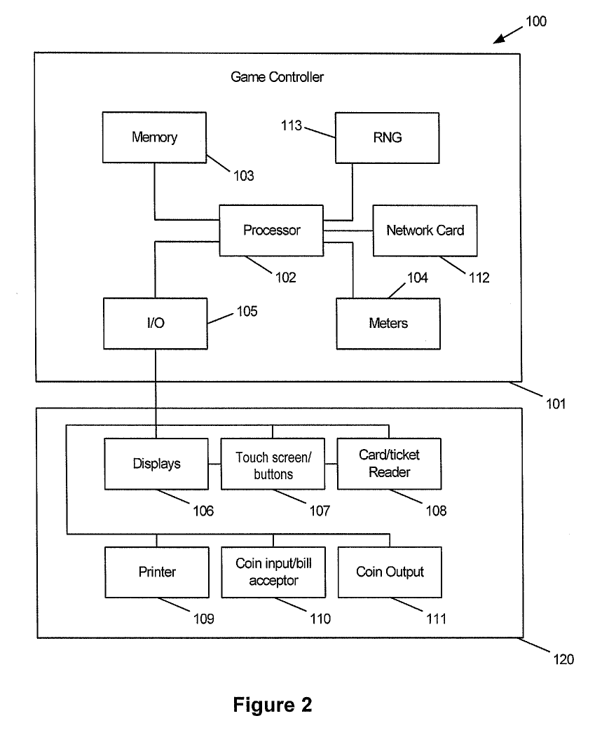

FIG. 2 shows a block diagram of operative components of a typical gaming machine. The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers. In some embodiments the random number generator may 113 be a mechanical random result generator, such as a card dealer, dice roller or the like.

In the example shown in FIG. 2, a player interface 120 includes peripheral devices that communicate with the game controller 101 comprise one or more displays 106, a touch screen and/or buttons 107(which provide a game play mechanism), a card and/or ticket reader 108, a printer 109, a bill acceptor and/or coin input mechanism 110 and a coin output mechanism 111. Other credit input mechanisms may also be employed, for example, a card reader for reading a smart card, debit card or credit card. Other gaming machines may configure for ticket in such that they have a ticket reader for reading tickets having a value and crediting the player based on the face value of the ticket. Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

The gaming machine 100 may also include a communications interface, for example a network card 112. The network card may, for example, send status information, accounting information or other information to a central controller, server or database and receive data or commands from the central controller, server or database. In embodiments employing a player marketing module, communications over a network may be via player marketing module—i.e. the player marketing module may be in data communication with one or more of the above devices and communicate with it on behalf of the gaming machine.

It is also possible for the operative components of the gaming machine 100 to be distributed, for example input/output devices 106,107,108,109,110,111 to be provided remotely from the game controller 101.

Embodiments of gaming systems can be adapted to detect whether a person is near a player interface. If the player interface is not in use, the availability of the player interface can be advertised to attract the person's attention to invite or encourage them to play the game. Player detection functionality can be applied to: stand alone game systems; networked game systems, where the game controller is remote from the player terminal; or multi player terminal game systems, where a plurality of player interfaces are provided to enable multiple players to simultaneously play a game using one random result generation process.

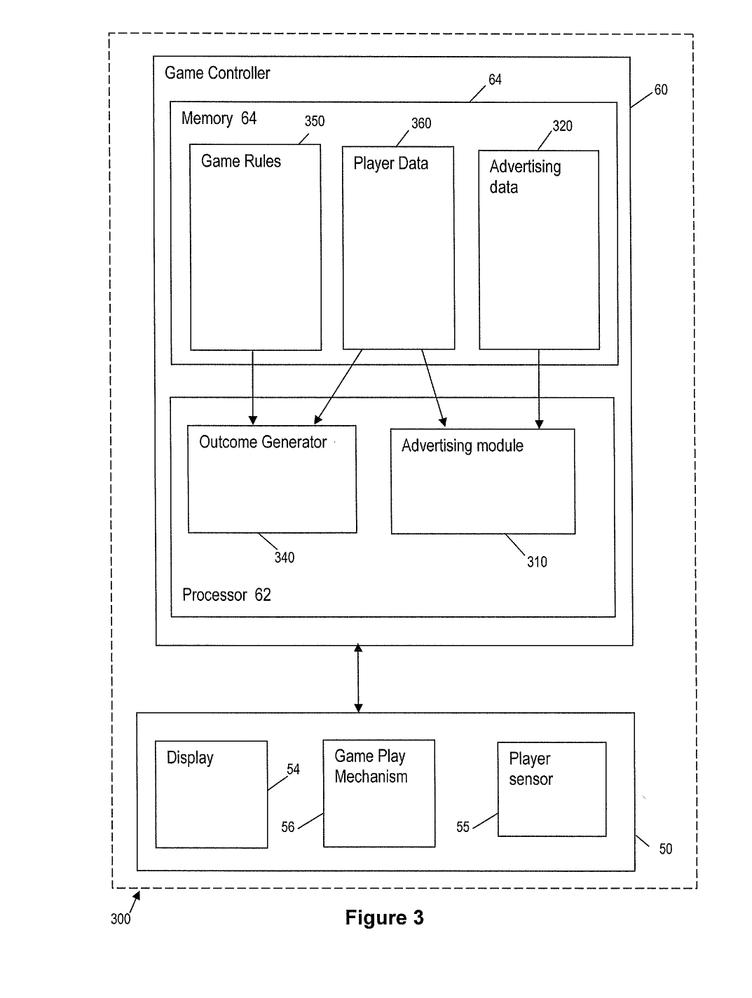

A block diagram of a gaming system including a player sensor is illustrated in FIG. 3. The gaming system 300 includes a game controller 60, a player interface 50, an advertising module 310 and a player sensor 55 adapted to detect a person proximate the player interface 50. When a person is detected and the player interface 50 is not already in use for game play, the advertising module 310 is triggered to advertise availability of the player interface 50.

In the illustrated example the sensor 55 is provided in the player interface 50. However, the sensor 55 may be provided external to the player interface 50. Location and number of player sensors may be adapted to suit the game system implementation. For example, a stand alone game system may have only one sensor, embedded in the game controller. A multiple terminal game system having a plurality of player interfaces and a single game controller may have a plurality of sensors, one for each player interface. A networked gaming system having a plurality of player interface connected via a network, such as a local area network, to one or more game controllers may have a plurality of sensors also connected to the game controller via the network, but these sensors may be external to the player interfaces, for example mounted in the gaming venue ceiling or in the floor. Sensors can use any suitable sensing technology. For example, infrared sensors may be used to detect the presence of a person based on differences between the body temperature of the person and the surrounding ambient temperature. Ultrasound sensors adapted to emit and receive ultrasound waves can also be used. Using ultrasound sensors the presence of a person is detected based on emitting ultrasound waves and receiving reflected ultrasound waves and detecting the presence of a person through changes in the received reflected ultrasound waves. Changes in the received ultrasound waves can also be used to determine whether the person is moving towards or way from the sensor. Pressure sensors, such as piezoelectric sensors, may be applied to the floor. For example the sensors may be embedded in the floor or a floor covering, such as a mat or carpet. The sensors generate a signal in response to the pressure applied by a person standing or walking on or near the sensor.

In the illustrated example the game controller 60 has a memory 64 and a processor 62. Functions of the game controller 60, such as the game outcome generator 340, are implemented as programs which are executed by the processor 62. In this example the advertising module 310 is implemented as software program executed by the game controller processor 62. However, in alternative embodiments the advertising module may be implemented independently of the game controller 60, for example as a function of a player interface 50 or as an independent advertising module.

The advertising module 310 of this example is adapted to receive a signal from the sensor 55 indicating a person proximate the player interface 50. The advertising may be connected directly to the sensor 55 in order to receive the signal. Alternatively, the signal may be sent to the advertising module via a gaming network. For example, where sensors are provided in the floor or ceiling these may be networked together such that any signal generated is received by a sensor server connected to the gaming network. The sensor server can then forward the signal via the gaming network to trigger the advertising module 310.

The player interface may be adapted inhibit sending player detection signals to the advertising module 310 while the player interface 50 is in use. Alternatively the advertising module 310 may be adapted to determine from the game controller 60 whether the player interface is already being used for game play when a player detection signal is received. The advertising module 310 advertises the availability of the player interface to the detected person. Advertising the player interface availability may be done in any manner suitable for the gaming system in order to draw the attention of the person to the available player interface. For example, the adverting module may trigger flashing lights on the player interface, an advertisement on a screen type display, play audio sounds or an advertising message, light up a sign etc, including combinations of two or more advertising actions.

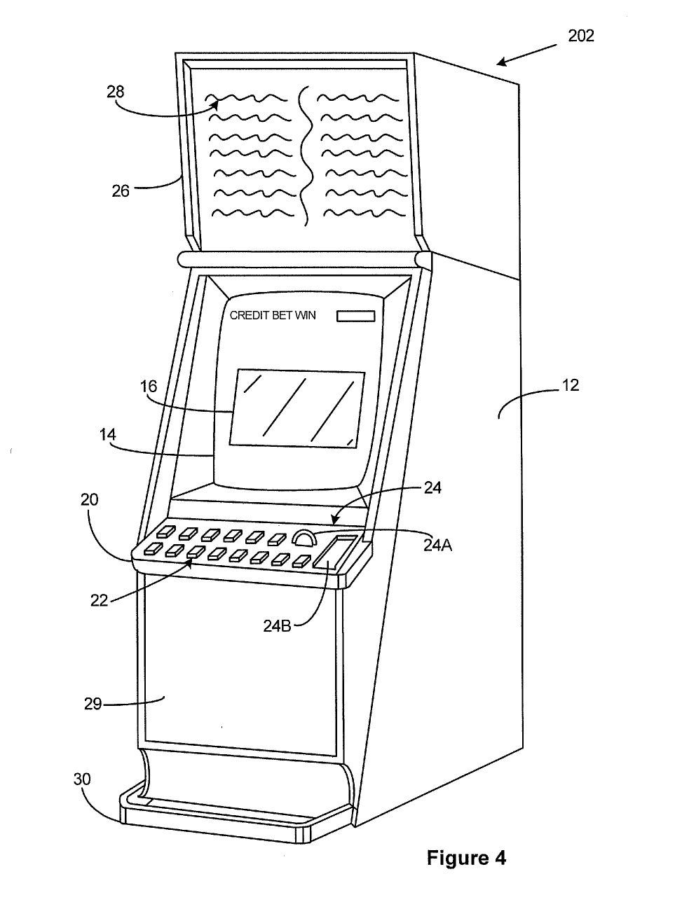

An example of a gaming system in the form of a stand alone gaming machine 202 is illustrated in FIG. 4. The gaming machine 202 includes a console 12 having a display 14 on which is displayed representations of a game 16 that can be played by a player. A mid-trim 20 of the gaming machine 202 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticket. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 202.

The display 14 shown in FIG. 4 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

A player sensor may be provided in any suitable part of the stand alone gaming machine 202. Logically, for this example it is desirable to detect the presence of a person in front of the gaming machine in view of the top box artwork 26 and display 14 which indicate the game available for play. For example the sensor may be provided in the mid trim or top box 26 so that the sensing field of the sensor covers a zone proximate extending away from the front of the game machine for a set distance, for example three meters. The set distance may be based on the sensing range of the sensor and may be adjustable, for example by adjusting sensor power or via sensor signal processing, for example adjusting a threshold indicative of distance from the sensor. For example, one or more sensors may be connected to a sensor circuit on a printed circuit board. The sensor circuit can include a digital signal processor (DSP) adapted to determine whether a person is detected based on sensor output signals. For example, the digital signal processor may be programmed to identify characteristics of the sensor output signals. These characteristics can be indicative of a person standing in front of the gaming machine. These characteristics can be used to distinguish a person from other objects or background movement. For example an infrared sensor may output a different signal when detecting a person having a higher body heat than the ambient temperature, than when detecting a chair. Alternatively, the output from an ultrasound sensor may be analyzed by the Digital signal processor to determine the direction a person is moving. For example, whether a person is moving towards, away or past a player interface based on differences in the wavelength of ultrasound waves reflected. Digital signal processing can be used to analyze the sensor output signals and to determine the movement direction. A player detection signal can be output from the sensor circuit based on the analysis outcome.

An advertising module, adapted to receive a player detection signal from the sensor circuit, can be provided in the gaming machine. The advertising module can be adapted to advertise the availability of the gaming machine by doing any one or more of: making noises, illuminating artwork 28 on the top box 26, illuminating or flashing mid trim buttons 22, showing a message or image on the display 16 or the like. For example, the advertising module may be implemented as a program executable by the game controller processor. In response to a player detection signal, the advertising module may play a video or animation on the display. The advertising module may also control flashing of lights or buttons and playing sounds using the speakers.

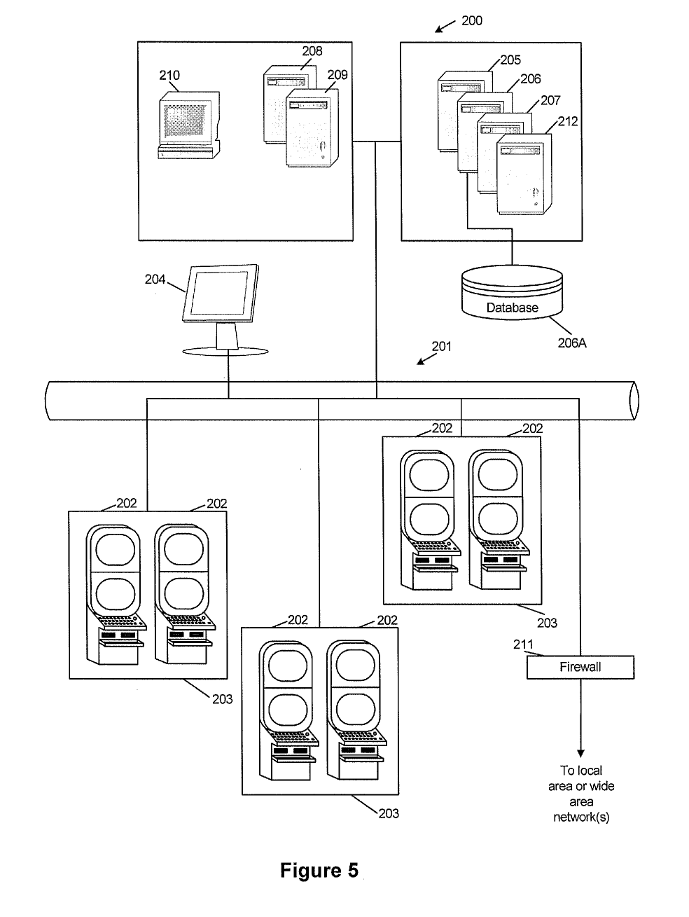

FIG. 5 shows an example of a distributed gaming system 200 in accordance with another embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 100, 202 shown in FIG. 2 or 4, or may have simplified functionality, depending on the requirements for implementing game play. While banks 203 of two gaming machines are illustrated in FIG. 5, banks of one, three or more gaming machines are also envisaged.

In this example one or more sensors may be associated with each bank 203 of gaming machines, wherein the one or more sensors for each bank 203 can be used to detect a person in a zone proximate the bank 203 of machines and/or in a zone proximate each machine of the bank. For example, where a single sensor is used for a bank of two machines, the area in which the sensor is adapted to detect the presence of a person may be divided up into zones, each zone being proximate one of the game machines 202 of the bank 203. The sensor generates a signal when a person is in the detection area proximate the bank 203 of machines and signal processing may be used to determine in which zone the person is detected in to trigger an advertisement module to advertise the proximate game machine's availability for game play. Alternatively, both game machines may be advertised, if available. If the person is detected proximate an occupied game machine, but another game machine of the bank is available the available game machine may be advertised. Selection of the game machine to advertise may be a function of an advertising module implemented in a game server 205 in data communication with the sensors via the network 201. It should be appreciated that in this example the sensors may be remote from the game machines or embedded in the game machines, depending on the embodiment implemented.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

The displays 204 may also be used by the advertising module to advertise the availability of gaming machines to players detected proximate the gaming machines in areas where the displays are visible. Advertising the availability of game machines 202 using the displays 204 may supplement adverting by the game machine. For example, the display may indicate that a game machine is available for play simultaneously with lights flashing and music sounding on the available game machine. This can have an advantage where the displays are viewable when facing away from the game machine. For example, a potential player may not be facing the game machine when their presence is detected proximate the game machine. However, the detected player may notice the availability of a machine advertised on the display 204 and turn around to look for the available game machine.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game. This is an example of a game system where a sensor and advertising module may be provided in each gaming device 202, enabling the functionality of each player interface 202 to detect the presence of a player proximate the player interface 202 and advertise availability of the device for game play. Data such as how often persons were detected proximate a player interface, how often each player interface was advertised available, how often a detected person was enticed to play the game etc, may be monitored and fed back to a server 212 for tracking purposes.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of client/server architecture can be found in WO 2006/052213 and PCT/SE2006/000559, the disclosures of which are incorporated herein by reference.

In this embodiment, sensors may be implemented external to the gaming machines and in data communication with an advertising module server 212 via the network. Such an embodiment minimizes the functionality required in the player interfaces and also enables the player interfaces 202 to be maintained or modified independent of the sensors. Alternatively, sensors may be provided in player interfaces 202. The player interfaces are then adapted to send player detection signals to an advertising module server 212 via the network. In response to a player detection signal, the advertising module may transmit advertising data to the player interface via the network for display.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

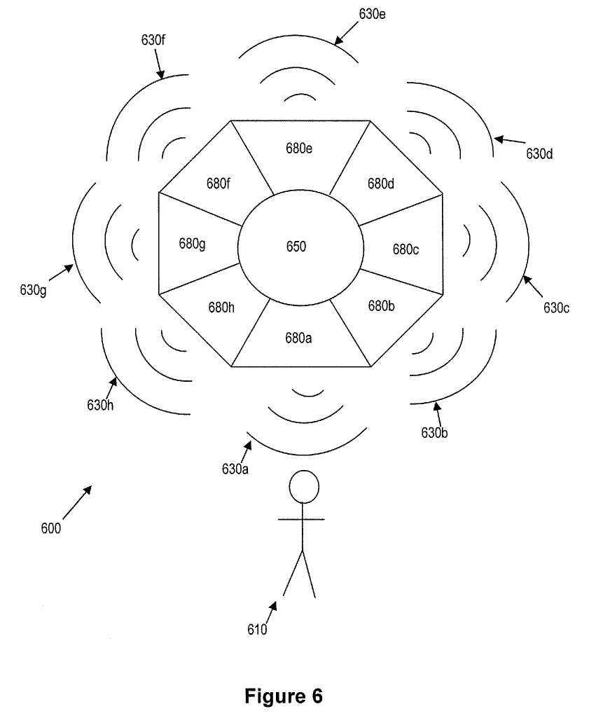

In the example illustrated in FIG. 6 the multi terminal gaming machine 600 comprises a controller 650 which is in data communication with a plurality of player interfaces 680a-h. The controller 650 can include a random result generator and a processor. The random result generator may be a mechanical random result generator, for example a card dealer, dice roller or roulette wheel The processor processes the game play instructions and random results generated by the random result generator in accordance with game play rules and outputs game play outcomes to the player interfaces 680a-h. The controller 650 is adapted for all players to play the one game. For example, all players can place wagers on the outcome of a single result generation instance, such as a dice roll. The outcome determined for each player is dependent on the generated result, the game rules for the game being played and the wager placed by the player.

Each of the player interfaces 680a-h includes a credit mechanism, a player input mechanism and a display. The credit mechanism enables a player to input credits and receive payouts. The player input mechanism enables a player enter game play instructions, which can include an amount to wager for a game round. The display can be used to display game information and outcomes to the player. The display may be a video display unit, such as a cathode ray tube screen device, a liquid crystal display, plasma screen, any other suitable video display unit. A player interface may be provided with more than one display unit or type of display for example a player interface may be provided with a screen type display and another form of display such as a series or lights or a panel of selectively illuminated symbols. Different game information may be communicated by each display. The displays can also be use to advertise the availability of the player interface for game play. It should be appreciated that the number of player interfaces can vary depending on implementation of the multi terminal game machine. In one example a multi terminal game machine may include only two player interfaces. In other embodiments the multi terminal game machine may have five, seven, eight, ten or more player interfaces. The number of player interfaces can be based on the game played on the machine, gaming venue preference, floor-space available etc.

In some embodiments of multi terminal game machines sensors can be provided to detect the presence of one or more potential players proximate one or more player interfaces. For example in the multi terminal game machine 600 illustrated in FIG. 6, each player interface 680a-h can be provided with a sensor to detect the presence of a person within range 630a-h of the sensor proximate the respective player interface 680a-h.

An advertising module may be provided in the controller 650 to advertise the availability of the game for play in response to a detection signal from a sensor. For example, as a person 610 comes within sensing range 630a proximate a player interface 680a the sensor detects the person 610. The sensor sends a detection signal to the advertising module. The advertising module can be adapted to determine whether the player interface 680a is available and if so trigger advertising of the availability of the player interface for game play, for example by flashing lights on the player interface 680a or game machine 600, playing a jingle, and/or showing an animated advertisement on the player interface 680a display.

In an embodiment an advertising module can be provided for each player interface 680a-h and each advertising module can be adapted to advertise the availability of the player interface to a detected person independently, or in communication with the game controller. For example, if no player interfaces are in use and a player is detected proximate a player interface, game controller may trigger the advertising module in every player interface to advertise the availability of the game. This may have more of an impact in capturing attention and enticing players than simply advertising the game using one player interface.

The sensors may be adapted to constantly, periodically or intermittently sense for players depending on the embodiment implemented. Further, a sensor and/or advertising module for a player interface may be deactivated while the player interface is in use. For example, when a player begins to play a game using the player interface a signal may be sent by the player interface or game controller to deactivate the sensor for the zone proximate the player interface or to the adverting module indicating the player interface is in use.

The sensor may be reactivated after given period of time to determine whether the person is still at the player interface, or activated in response to a signal from the game controller or player interface after play finishes. Play finishing may be determined by any appropriate means, for example by a player requesting payout and removing a card from a card reader. Alternatively, if player interface is inactive for a given period of time this may be interpreted as game play finishing and the sensor and adverting module reactivated.

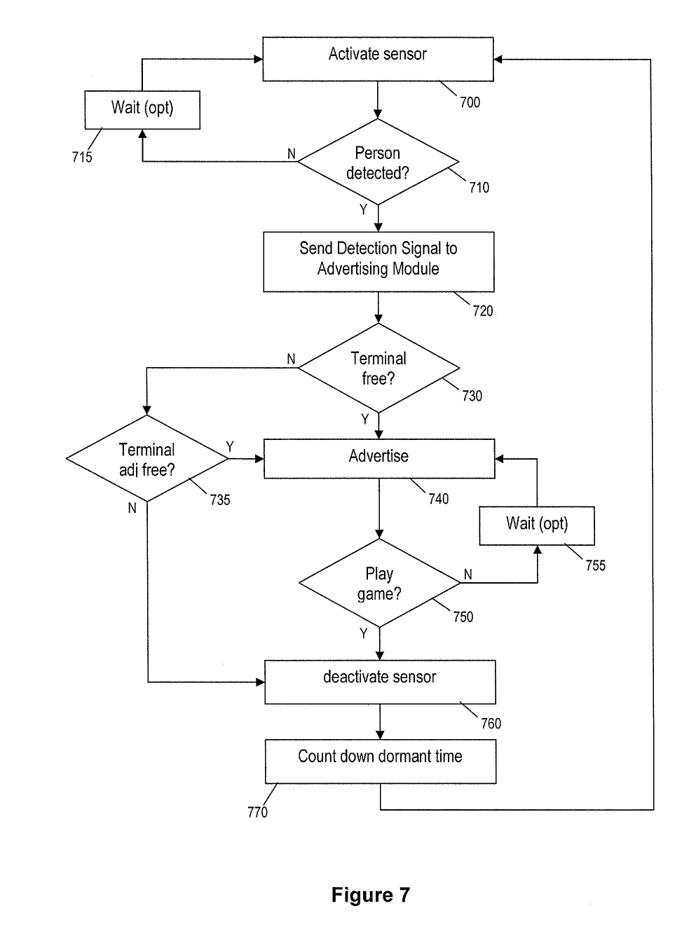

An example of the process or detecting a player and advertising availability of a player interface is illustrated in FIG. 7. A sensor is activated 700 for detection of the presence of a player proximate a player interface. The sensor can continually sense for a person entering the zone and only initiate further action when the presence of a person is detected 710. Alternatively, the sensor may periodically scan the zone for presence of a person. For example, if a person is not detected 710 when the sensor is activated, the sensor may optionally wait in a dormant state for a given period 715 before scanning again. This can be repeated until a person is detected.

When the presence of a person is detected by the sensor a detection signal is sent 720 to the advertising module. The advertising module can determine whether the player interface is available 720 and if so advertise the available interface 740 to the detected person. The advertising module may be adapted to determine whether the person begins playing the game 750 and if so deactivate the sensor 760 for a period of time 770 or until the person ceases to play the game.

If the person does not begin to play the game 750, the advertising module can be adapted to advertise the game again 740, optionally after a short time delay 755. The adverting module may be adapted to use a series of different adverting techniques to attract the person to the game. The adverting module may be adapted to cease advertising the game after a period of time or when the player is no longer detected.

The player interface may not available 720, for example, if the detected person is already playing the game, or if the player interface is already in use and an additional person been detected proximate the player terminal. In an example of a multi terminal game machine having a plurality of player interface, an adjacent player interface may be available even if the proximate player interface is already in use. In this example the advertising module may be adapted to determine whether an adjacent player interface is available 735, and advertise 740 one or more adjacent available player interfaces. If no adjacent player interfaces are available or the advertising module is not adapted to check for available adjacent interfaces the sensor may be deactivated 760 for a period of time 770 before being activated again, or deactivated until a player interface becomes available.

Embodiments may be adapted to advertise more than one available player interface, for example a bank of available interfaces or interfaces adjacent both sides of an occupied player interface, in response to a player being detected proximate a player interface.

Sensors can be always on, periodically turned on, periodically or randomly scan to detect players. Timing of sensors scanning or detecting periods may be synchronized to avoid interference from sensors of adjacent machines or player interfaces.

Advertising may be limited to avoid annoying or distracting current players. For example, the number of times a minute a player interface may advertise its availability may be limited say to 6 times a minute. Alternatively, the timing of advertising may be limited to certain times during game play, and may be based on the type of game. For example, for a card game advertising may be limited for a period of time to enable a player to concentrate on their strategy while placing a bet, and unlimited between hands, whereas advertising may be unlimited for a roulette game.

It should be appreciated that any type of sensor suitable for detecting the presence of a person may be used in various embodiments. An example of a suitable sensor technology is infrared sensors adapted to detect the presence of a person based on difference between body heat and ambient temperature. Another suitable sensor technology is ultrasound sensors adapted to emit and receive ultrasound waves and detect the presence of a person based on ultrasound waves reflected by the person. Alternative sensor technologies are considered within the scope of various embodiments and the following claims.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

It is to be understood that, if any prior art publication is referred to herein, such reference does not constitute an admission that the publication forms a part of the common general knowledge in the art, in any country.

1. A gaming system comprising:
a game controller adapted to control game play;
at least one player interface in data communication with the game controller and operable by a player to enter game play instructions;
an advertising module; and
at least one sensor adapted to detect a person proximate a player interface and trigger the advertising module to advertise availability of the player interface when the player interface is not in use.

2. A gaming system as claimed in claim 1 wherein the game system comprises a plurality of player interfaces.

3. A gaming system as claimed in claim 2 wherein at least one sensor is provided for each player interface.

4. A gaming system as claimed in claim 2 wherein an advertising module is implemented for each player interface.

5. A gaming system as claimed in claim 1 wherein the advertising module is implemented in the game controller.

6. A gaming system as claimed in claim 1 wherein the game controller is in data communication with the sensors, whereby the game controller receives a signal generated by a sensor when a person is detected by the sensor and the game controller is adapted to determine whether the detected person is proximate an unused player interface and trigger advertisement of the availability of the player interface.

7. A gaming system as claimed in claim 1 further adapted to determine whether a person detected proximate a player interface is moving towards or away from the player interface.

8. A gaming system as claimed in claim 1 wherein advertising the availability of a player interface comprises one or more of flashing lights and making sounds.

9. A gaming system as claimed in claim 1 wherein the sensors are infrared sensors adapted to detect the presence of a person based on detecting a difference between body heat of a person and ambient temperature.

10. A gaming system as claimed in claim 1 wherein the sensors are ultrasound sensors adapted to emit and receive ultrasound waves and detect the presence of a person based on ultrasound waves reflected by the person.

11. A gaming system as claimed in claim 10 wherein the sensor is adapted to determine whether the person is moving toward or away from a player interface based on changes in reflected ultrasound waves.

12. A player interface for a game system, the player interface comprising:
an input mechanism adapted to enable a player to enter game play instructions;
a sensor adapted to detect a person proximate the player interface; and
an advertising module adapted to, in response to detection of a person in the zone when the player interface is not in use, advertise availability of the player interface.

13. A player interface as claimed in claim 12 wherein the sensor is an ultrasound sensor.

14. A player interface as claimed in claim 12 wherein the sensor is an infrared sensor.

15. A method of advertising availability of a gaming system for play comprising the steps of:
detecting the presence of a person proximate a player interface of the game system;
determining whether the player interface is in use by a player; and
advertising the availability of the player interface.

16. A method as claimed in claim 15 wherein the gaming system comprises a plurality of player interfaces and the step of detecting the presence of a person proximate a player interface includes determining which of the plurality of player interfaces the person is proximate to.

17. A method as claimed in claim 15 wherein a detection area proximate the player terminal is based on a sensing range of at least one sensor in at least one direction from the player interface.

18. A method as claimed in claim 17 further comprising the step of adjusting the detection area.

19. A method as claimed in claim 15 wherein the step of detecting the presence of a person includes:
activating a sensor;
sensing the presence of a person within sensing range of the sensor;
determining whether the person is proximate a player interface; and
signaling the detected presence of the person proximate the player interface.

20. A method as claimed in claim 19 wherein the step of detecting the presence of a person further comprises determining whether the person is moving towards or away from the sensor.
